(19) United States
(12) Patent Application Publication
(10) Pub. No.: US 2026/0311444 A1
(43) Pub. Date: Oct. 8, 2026

(54) VISION LARGE LANGUAGE MODEL PREPROCESSING APPARATUS AND METHOD

(71) Applicants: HYUNDAI MOTOR COMPANY, Seocho-gu (KR); Kia Corporation, Seocho-gu (KR)

(72) Inventors: Yujin LEE, Gyeonggi-do (KR); Moonsub JIN, Gyeonggi-do (KR); Chan Woong KWAK, Gyeonggi-do (KR)

(21) Appl. No.: 19/401,643

(22) Filed: Nov. 26, 2025

(30) Foreign Application Priority Data
Apr. 7, 2025 (KR) 10-2025-0044891

(51) Int. Cl. G06V 10/25; G06V 10/82

(52) U.S. Cl. CPC G06V 10/25; G06V 10/82

(57) ABSTRACT

A vision large language model (LLM) preprocessing method performed by a computing device including a processor and a memory, where the method includes receiving, by the processor, a first image and a first prompt, setting, by the processor, a region of interest in the first image based on the first prompt and determining, by the processor, a similarity level between an image cropped from the region of interest and the first prompt, selectively outputting, by the processor, a second image from the region of interest based on the similarity level, and inputting, by the processor, the output second image and the first prompt into the vision LLM.

### CROSS-REFERENCE TO RELATED APPLICATION

This application claims priority to and the benefit of Korean Patent Application No. 10-2025-0044891 filed with the Korean Intellectual Property Office on Apr. 7, 2025, the entire contents of which are incorporated herein by reference.

### TECHNICAL FIELD

The present disclosure relates to vision large language model (LLM) preprocessing apparatus and method, and more particularly, to vision LLM preprocessing apparatus and method for preprocessing an image and a prompt to improve performance of a vision LLM.

### BACKGROUND

When traveling, a robot must rapidly recognize its surrounding environment and continue operating even in areas without communication access. To enable this, artificial intelligence (AI) inference is often performed directly on the device. For this reason, on-device AI has become a critical capability in the field of autonomous systems.

Recently, large language models (LLMs), trained on extensive datasets with billions of parameters, have emerged and significantly outperformed traditional language models, ushering in a new era of generative AI.

LLMs are no longer confined to natural language processing. They have evolved into vision LLMs that accept both text and image inputs, and demonstrate superior performance compared to conventional convolutional neural network (CNN)-based models in computer vision tasks.

However, deploying vision LLMs for on-device inference remains challenging due to their large model size and computational demands.

### SUMMARY

The present disclosure is directed to a vision large language model (LLM) preprocessing apparatus and a method for cropping a region appropriate for a prompt from an entire image and inputting the same as additional information to improve performance of a model without increasing a resource for model inference in an environment having a limited computing environment (i.e., an edge device).

The present disclosure is also directed to a vision LLM preprocessing apparatus and a method for inputting an entire image and a region of interest (ROI)-based crop image simultaneously and modifying a prompt to be appropriate therefor.

According to one aspect of the present disclosure, a vision large language model (LLM) preprocessing method performed by a computing device including a processor and a memory can include receiving, by the processor, a first image and a first prompt, setting, by the processor, a region of interest in the first image based on the first prompt and determining, by the processor, a similarity level between an image cropped from the region of interest and the first prompt, selectively outputting, by the processor, a second image from the region of interest based on the similarity level, and inputting, by the processor, the output second image and the first prompt into the vision LLM.

In some implementations, setting the region of interest in the first image and determining the similarity level can include detecting, by the processor, a candidate image from the region of interest by using an artificial intelligence-based object detection model, calculating, by the processor, a similarity level between the detected candidate image and the first prompt, and determining, by the processor, whether the calculated similarity level satisfies a specific criterion. In some examples, detecting the candidate image from the region of interest can includes outputting, by the processor, a bounding box that includes an object, determining, by the processor, whether the output bounding box satisfies a specific condition and determining, by the processor, the object included in the bounding box as the candidate image based on the output bounding box satisfying the specific condition.

In some examples, determining whether the output bounding box satisfies the specific condition and determining the object included in the bounding box as the candidate image based on the output bounding box satisfying the specific condition can include determining, by the processor, the object included in the bounding box as the candidate image based on a size of the bounding box being greater than a size of the first image multiplied by a predetermined multiple. In some implementations, calculating the similarity level between the candidate image and the first prompt can include calculating, by the processor, the similarity level between the candidate image and the first prompt by using a sigmoid loss contrastive language-image pre-training (SIGLIP) model.

In some examples, determining whether the similarity level satisfies the specific criterion can include determining, by the processor, that the similarity level satisfies the specific criterion based on a highest similarity level among the calculated similarity levels exceeds a predetermined threshold criterion and outputting the second image. In some implementations, inputting of the second image and the first prompt into the vision LLM can include inputting, by the processor, the first image and the second image into the vision LLM.

In some examples, inputting the second image and the first prompt into the vision LLM can further include inputting, by the processor, the first image, the second prompt, and the first prompt into the vision LLM, the second prompt including a description of the second image. In some implementations, selectively outputting the second image to the region of interest can further include inputting, by the processor, the first image and the first prompt into the vision LLM in response to the second image not being output.

According to another aspect of the present disclosure, a vision large language model (LLM) preprocessing method performed by a computing device including a processor and a memory can include receiving, by the processor, an entire image and an input prompt, setting, by the processor, a region of interest in the entire image based on a first prompt and determining a similarity level between a candidate image included in the region of interest and the input prompt, determining, by the processor, the candidate image as an image of interest and outputting, based on the similarity level exceeding a threshold criterion, the determined candidate image, inputting, by the processor, the entire image and the input prompt into the vision LLM based on the image of interest not being output, and modifying, by the processor, the input prompt to correspond to both the entire image and the image of interest and inputting, based on the image of interest being output, the modified input prompt, the entire image, and the image of interest into the vision LLM.

According to another aspect of the present disclosure, a vision large language model (LLM) preprocessing apparatus for improving inference performance. The LLM preprocessing apparatus can include at least one memory device storing program codes, and at least one processor configured to execute the program codes to perform operations. The operations can include receiving a first image and a first prompt, setting a region of interest in the first image based on the first prompt and determining a similarity level between an image cropped from the region of interest and the first prompt, selectively outputting a second image from the region of interest based on the similarity level, and inputting the output second image and the first prompt into the vision LLM.

In some implementations, setting the region of interest in the first image and determining the similarity level can include detecting a candidate image from the region of interest by using an artificial intelligence-based object detection model, calculating a similarity level between the detected candidate image and the first prompt, and determining whether the calculated similarity level satisfies a specific criterion. In some examples, detecting the candidate image from the region of interest can include outputting a bounding box that includes an object, determining whether the output bounding box satisfies a specific condition and determining the object included in the bounding box as the candidate image based on the output bounding box satisfying the specific condition.

In some examples, determining whether the output bounding box satisfies the specific condition and determining the object included in the bounding box as the candidate image based on the output bounding box satisfying the specific condition can include determining the object included in the bounding box as the candidate image based on a size of the bounding box being greater than a size of the first image multiplied by a predetermined multiple. In some implementations, calculating the similarity level between the candidate image and the first prompt can include calculating the similarity level between the candidate image and the first prompt by using a sigmoid loss contrastive language-image pre-training (SIGLIP) model.

In some implementations, determining whether the similarity level satisfies the specific criterion can include determining that the similarity level satisfies the specific criterion based on a highest similarity level among the calculated similarity levels exceeds a predetermined threshold criterion and outputting the second image. In some implementations, inputting the second image and the first prompt into the vision LLM can include inputting the first image and the second image into the vision LLM.

In some examples, inputting the second image and the first prompt into the vision LLM can further include inputting the first image, the second prompt, and the first prompt into the vision LLM, the second prompt including a description of the second image. In some implementations, selectively outputting the second image from the region of interest can further include outputting, based on the similarity level satisfying the specific criterion, the second image, and not outputting, based on the similarity level not satisfying the specific criterion, the second image. In some implementations, not selectively outputting the second image from the region of interest based on the similarity can further include inputting the first image and the first prompt into the vision LLM.

### BRIEF DESCRIPTION OF THE DRAWINGS

FIG. 1 is a diagram illustrating an example of a vision large language model (LLM) preprocessing apparatus and method.

FIG. 2 is a block diagram illustrating an example of the vision LLM preprocessing apparatus.

FIG. 3 is a block flow diagram illustrating an example of the vision LLM preprocessing apparatus.

FIG. 4 is a flow diagram illustrating an example of a vision LLM preprocessing method.

FIGS. 5A, 5B, and 6 are diagrams illustrating an example for describing the vision LLM preprocessing method.

FIG. 7 is a table illustrating an example for describing an effect of the vision LLM preprocessing apparatus and method.

FIG. 8 is a diagram illustrating an example of a computing device.

### DETAILED DESCRIPTION

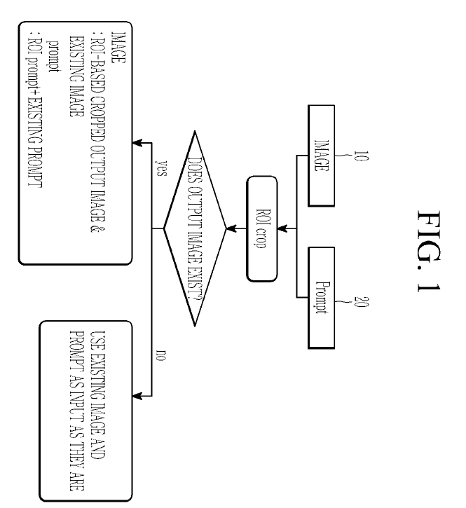

FIG. 1 is a diagram illustrating an example of a vision large language model (LLM) preprocessing apparatus and method. FIG. 1 is a diagram showing a process for the vision LLM preprocessing apparatus performing the vision LLM preprocessing method.

In some implementations, the vision LLM preprocessing method can be performed by the vision LLM preprocessing apparatus.

The vision LLM preprocessing apparatus can receive an image 10 and a prompt 20.

The vision LLM preprocessing apparatus can crop a region of interest (ROI) based on the input image 10 and the prompt 20.

The vision LLM preprocessing apparatus can determine a similarity level between a specific image included in the cropped region of interest and the prompt 20.

The vision LLM preprocessing apparatus can output the specific image if the determined similarity level satisfies a specific criterion.

The vision LLM preprocessing apparatus may not output the specific image if the similarity level does not satisfy the specific criterion.

The vision LLM preprocessing apparatus can input the initially input image 10 together with an output image into the vision LLM if the output image exists. For example, the vision LLM preprocessing apparatus can input an ROI prompt describing the output image together with the initial prompt 20 into the vision LLM.

The vision LLM preprocessing apparatus can use the initially input image 10 and the prompt 20 as input as they are into the vision LLM if the output image does not exist.

For example, the vision LLM preprocessing apparatus can set the ROI by reflecting the input (prompt) requested by a user and input the set ROI into the vision LLM. The vision LLM preprocessing apparatus can simultaneously input an entire image and an ROI-based cropped image, and use the prompt by modifying the prompt to be appropriate for the input.

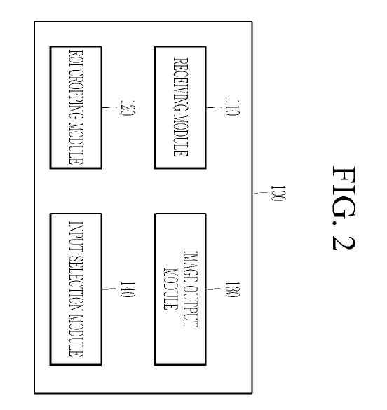

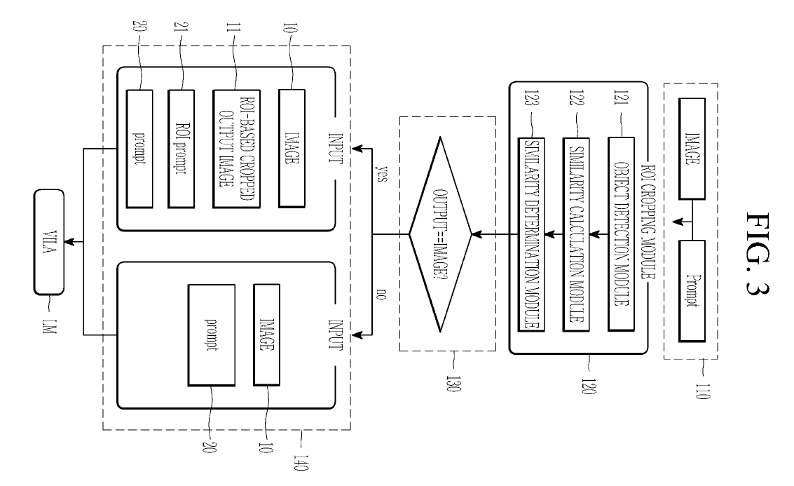

FIGS. 2 and 3 are diagrams illustrating an example of the vision LLM preprocessing apparatus.

FIG. 2 is a block diagram illustrating an example of the vision LLM preprocessing apparatus. FIG. 3 is a block flow diagram illustrating an example of the vision LLM preprocessing apparatus.

Referring to FIGS. 2 and 3, a vision LLM preprocessing apparatus 100 can execute a program code or an instruction loaded into at least one memory device by using at least one processor.

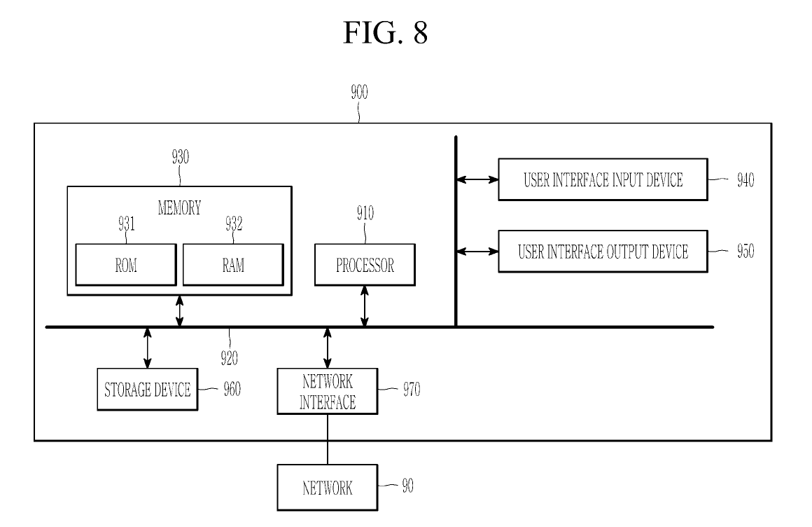

For example, the vision LLM preprocessing apparatus 100 can be implemented in a computing device 900 as described below with respect to FIG. 8. In some implementations, at least one processor may correspond to a processor 910 of the computing device 900, and at least one memory device may correspond to a memory 930 of the computing device 900.

The program code or the instruction can be executed by at least one processor to simultaneously input the entire image and the ROI-based cropped image to the vision LLM, and to input the prompt into the vision LLM by modifying the prompt to be appropriate for the input.

Referring to FIG. 2, the vision LLM preprocessing apparatus 100 can include a receiving module 110, an ROI cropping module 120, an image output module 130, and an input selection module 140.

Referring to FIGS. 2 and 3, the receiving module 110 can receive the image 10 and the prompt 20.

The image 10 can be the entire image 10 that is input into the vision LLM as an input image. The prompt 20 can be the input prompt 20 that includes various questions provided by the user.

The ROI cropping module 120 can set the ROI from the input image 10 based on the input prompt 20.

The ROI cropping module 120 can determine the similarity level between the image cropped from the ROI and the input prompt 20.

The ROI cropping module 120 can include an object detection module 121, a similarity calculation module 122, and a similarity determination module 123.

The object detection module 121 can detect a candidate image from the region of interest by using an artificial intelligence-based object detection model.

For example, the candidate image can serve as an object for determining similarity between the candidate image and the input prompt 20.

The object detection module 121 can output a bounding box that includes an object in the entire image.

The object detection module 121 can determine whether the output bounding box satisfies a specific condition.

The object detection module 121 can determine the object included in the bounding box that satisfies the specific condition as the candidate image.

For example, the object detection module 121 can determine the object included in the bounding box as the candidate image if a size of the bounding box is greater than a size of the entire image multiplied by a predetermined multiple.

The similarity calculation module 122 can calculate the similarity level between the detected candidate image and the prompt 20.

The similarity calculation module 122 can calculate the similarity level between the candidate image and the prompt 20 by using a contrastive language-image pre-training (CLIP) model or a sigmoid loss contrastive language-image pre-training (SIGLIP) model. For example, similarity between image-text pairs can include cosine similarity.

Contrastive language-image pre-training (CLIP) model can express an image and a text as embedding vectors by using an image encoder and a text encoder, respectively. The CLIP model can calculate cosine similarity between image-text vectors and train the encoder to output (i) high similarity for correct image-text pairs and (ii) low similarity for incorrect image-text pairs. Therefore, The CLIP model can measure a similarity level between the image and text by putting the image-text pair into a pre-trained model.

The SIGLIP model can refer to an extension of the CLIP model, and can provide improved performance by using sigmoid loss instead of contrastive learning used by CLIP.

The similarity determination module 123 can determine whether the calculated similarity level satisfies the specific criterion.

The similarity determination module 123 can determine that the calculated similarity level satisfies the specific criterion if the highest similarity level among the calculated similarity levels exceeds a predetermined threshold criterion.

The image output module 130 can selectively output an image 11 of interest from the region of interest based on the similarity level.

The image 11 of interest can be the ROI-based cropped output image 11.

The image 11 of interest can correspond to an output image having similarity to the input prompt 20 that is greater than or equal to the specific criterion among the images cropped from the ROI.

For example, the image output module 130 can output the image 11 of interest if the similarity level satisfies the specific criterion, and may not output the image 11 of interest if the similarity level does not satisfy the specific criterion.

The input selection module 140 can input the output image 11 of interest and the input prompt 20 into the vision LLM.

The input selection module 140 can input the entire image 10 together with the image 11 of interest into a vision LLM LM.

For example, the input selection module 140 can input the entire image 10 and an ROI-based prompt 21 including a description of the image 11 of interest together with the input prompt 20 into the vision LLM LM.

The input selection module 140 can input only the entire image 10 and the input prompt 20 as they are into the vision LLM LM if the output image is not selectively output from the region of interest based on the similarity level.

The vision LLM LM can be a multi-modal model configured to receive the text and the image and generate texts. The vision LLM LM can generate output text based on the prompt asking for description, inference, or the like of the image.

The vision LLM LM can include a visual language (VILA) model.

VILA LM can be a type of the vision LLM and can be a pre-trained model using image-text data. The VILA LM can infer multiple images and videos.

The VILA LM can include a visual encoder, a projector, a tokenizer, and an LLM. The visual encoder can vectorize the input image by using the image encoder, the projector can map an encoded image vector to input of the LLM, and the tokenizer can tokenize the vector. The LLM can generate the output text by using an image-text token.

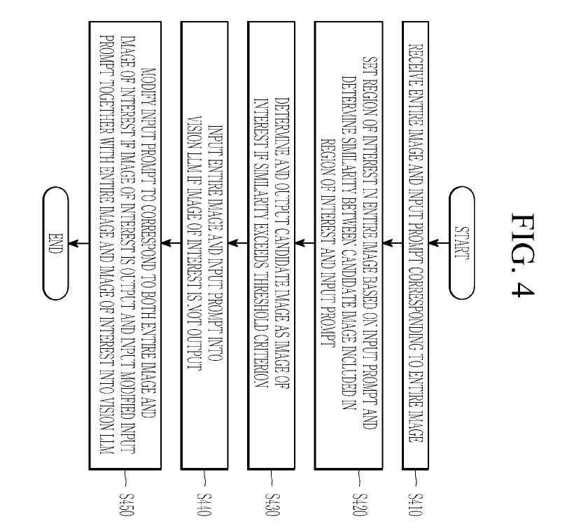

FIG. 4 is a flow diagram illustrating an example of a vision LLM preprocessing method. The vision LLM preprocessing method in FIG. 4 can be performed by the vision LLM preprocessing apparatus 100 in FIGS. 2 and 3.

Referring to FIG. 4, the vision LLM preprocessing apparatus 100 can receive the entire image and the input prompt corresponding to the entire image (S410).

The vision LLM preprocessing apparatus 100 can set the region of interest in the entire image based on a first prompt and determine the similarity level between the candidate image included in the region of interest and the input prompt (S420).

The vision LLM preprocessing apparatus 100 can determine and output the candidate image as the image of interest if the similarity level exceeds the threshold criterion (S430).

The vision LLM preprocessing apparatus 100 can input the entire image and the input prompt into the vision LLM if the image of interest is not output (S440).

The vision LLM preprocessing apparatus 100 can modify the input prompt to correspond to both the entire image and the image of interest if the image of interest is output and input the modified input prompt together with the entire image and the image of interest into the vision LLM (S450).

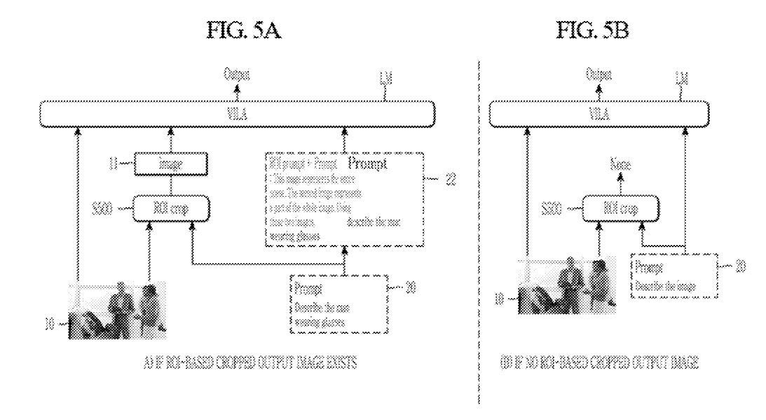

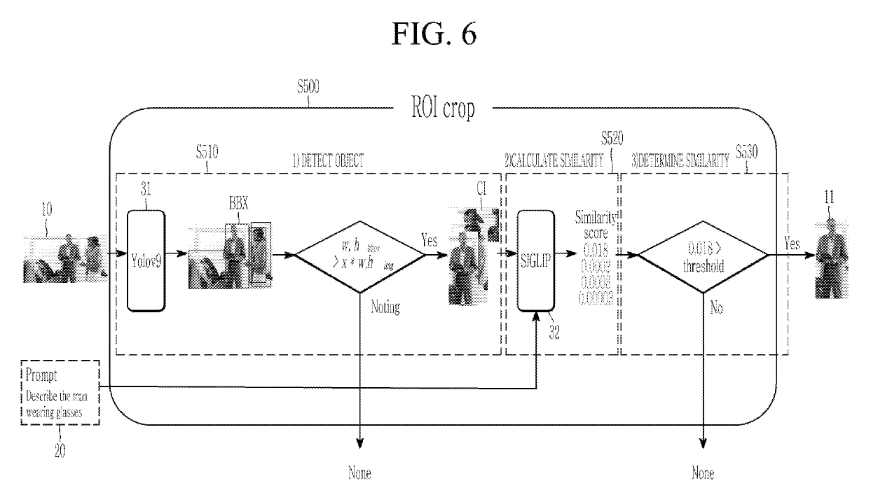

FIGS. 5A, 5B and 6 are diagrams illustrating an example for describing the vision LLM preprocessing method. The vision LLM preprocessing method can be performed by the vision LLM preprocessing apparatus 100 in FIGS. 2 and 3.

The vision LLM preprocessing apparatus 100 may output or not output the image 11 of interest by determining the similarity level between the candidate image generated based on ROI-based cropping of the entire image 10 and the input prompt 20 (S500).

FIG. 5A is a flowchart illustrating an example of the vision LLM preprocessing method if the ROI-based cropped output image exists. FIG. 5B is a flowchart illustrating an example of the vision LLM preprocessing method if no ROI-based cropped output image exists.

Referring to FIG. 5A, when the entire image 10 and the input prompt 20 are received, the vision LLM preprocessing apparatus 100 can set the region of interest in the entire image 10 based on the input prompt 20 and crop the set ROI to generate the candidate image (S500).

For example, the vision LLM preprocessing apparatus 100 can output the image 11 of interest if the similarity level between the candidate image and the input prompt 20 is greater than or equal to the predetermined specific criterion (S500).

The vision LLM preprocessing apparatus 100 can generate the ROI-based prompt 21 (see FIG. 3) for the image 11 of interest and the entire image 10.

The vision LLM preprocessing apparatus 100 can generate a final prompt 22 by coupling the ROI-based prompt 21 to the input prompt 20.

The vision LLM preprocessing apparatus 100 can input the entire image 10, the image 11 of interest, and the final prompt 22 into the vision LLM LM (for example, VILA).

If only the cropped image 11 of interest is used as input for the VILA LM, contextual information may be lost, as areas outside the region of interest are not visible. This could potentially lead to an incorrect answer.

Therefore, the vision LLM preprocessing apparatus 100 can use both the image 11 of interest and the entire image 10 as input.

In addition, the vision LLM preprocessing apparatus 100 can add the ROI-based prompt 21 before the input prompt 20 to efficiently utilize the entire image 10 and the image 11 of interest.

For example, the ROI-based prompt can be "<the entire image> This image represents the entire scene. <the image of interest> The second image represents a part of the whole image. Using these two images,").

The final prompt 22 can be "<the entire image> This image represents the entire scene. <the image of interest> The second image represents a part of the whole image. Using these two images, describe the man wearing glasses."

As shown in FIG. 5B, the vision LLM preprocessing apparatus 100 may not output the image 11 of interest if the similarity level between the candidate image and the input prompt 20 is less than the predetermined specific criterion (S500).

In some implementations, the vision LLM preprocessing apparatus 100 can input the entire image 10 and the input prompt 20 as they are into the vision LLM LM.

FIG. 6 is a flowchart illustrating an example for describing step S500 in FIG. 5.

As shown in FIG. 6, the vision LLM preprocessing apparatus 100 can detect a candidate image CI from the region of interest by using an artificial intelligence-based object detection model 31 (for example, Yolo9) (S510).

The vision LLM preprocessing apparatus 100 can output a bounding box(bbox) BBX to the region of interest.

The vision LLM preprocessing apparatus 100 can determine whether the output bounding box BBX satisfies the specific condition, and, if the output bounding box BBX satisfies the specific condition, the vision LLM preprocessing apparatus 100 can determine an object included in the bounding box BBX as the candidate image CI.

The vision LLM preprocessing apparatus 100 can determine the object included in the bounding box BBX as the candidate image CI only if a size of the bounding box BBX is greater than a size of the entire input image 10 multiplied by a predetermined multiple x.

For example, the vision LLM preprocessing apparatus 100 can determine the object included in the bounding box BBX as the candidate image CI if a bounding box height hbbox is greater than an entire image height himg multiplied by the predetermined multiple x, or, if a bounding box width wbbox is greater than an entire image width wimg multiplied by the predetermined multiple x.

Alternatively, the vision LLM preprocessing apparatus 100 can determine the object included in the bounding box BBX as the candidate image CI if the bounding box height hbbox is greater than the height himg of the entire image 10 that is multiplied by the predetermined multiple x, and, simultaneously, the bounding box width wbbox is greater than the entire image width multiplied by the predetermined multiple x.

For example, the vision LLM preprocessing apparatus 100 can block input degradation caused by an image size adjustment by filtering the bounding box BBX having an appropriate size or smaller, because quality degradation may occur during a size adjustment process if the bounding box BBX is too small.

For example, performance of the vision LLM on the dataset may significantly deteriorate starting from a case where the predetermined multiple x is 0.15. To mitigate this, the vision LLM preprocessing apparatus 100 can configure a range of the predetermined multiple x to be between 0.05 and 0.1.

The vision LLM preprocessing apparatus 100 can calculate the similarity level between the detected candidate image CI and the input prompt 20 (S520).

The vision LLM preprocessing apparatus 100 can calculate the similarity level between the candidate image CI and the input prompt 20 by using a sigmoid loss contrastive language-image pre-training (SIGLIP) model 32.

The similarity level can be expressed as a similarity score.

The vision LLM preprocessing apparatus 100 can determine whether the calculated similarity level satisfies the specific criterion (S530).

The vision LLM preprocessing apparatus 100 can output the image 11 of interest if a candidate image satisfying the specific criterion exists, and output a none value if no candidate image satisfying the specific criterion exists.

The vision LLM preprocessing apparatus 100 can determine and output that the image 11 of interest satisfies the specific criterion if the highest similarity level among the calculated similarity level exceeds the predetermined threshold criterion.

For example, the vision LLM preprocessing apparatus 100 can output the candidate image as the image 11 of interest if the highest similarity score (e.g., 0.018) among the similarity scores exceeds the threshold criterion.

The reason is that if no threshold criterion is set, the highest score may be used even if there is no region associated with the prompt, which may result in the incorrect answer.

That is, the vision LLM preprocessing apparatus 100 can use the image 11 of interest in the region associated with the input prompt 20 as additional input into the vision LLM.

The vision LLM preprocessing apparatus 100 can infer and filter the similarity for the image of interest in response to various questions included in the input prompt.

For example, the input prompt may ask about a specific person or object in the given image and may also include a question about overall context. In some implementations, the vision LLM preprocessing apparatus 100 can perform the filtering by inferring low similarity between the output image of interest and the question.

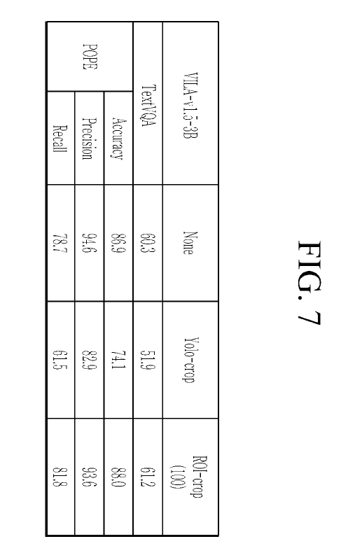

FIG. 7 is a diagram illustrating an example of a table for describing an effect of the vision LLM preprocessing apparatus and method.

The table can include numerical values showing improvement in accuracy compared to an existing model and a previous study when evaluating the performance for various tasks of the vision LLM by using the vision LLM preprocessing apparatus and method.

Text visual question answering (TextVQA) can refer to a dataset for evaluating text recognition performance in the image. Pointing and perceiving (POPE) can refer to a dataset for evaluating classification performance of the presence or absence of an object in the image.

Referring to FIG. 7, it may be seen that the numerical value indicating accuracy is greater when the LLM preprocessing apparatus 100 and the LLM preprocessing method (ROI-based cropping) are used, compared to when the existing model (none or yolo-cropping) is applied to the performance evaluation dataset.

FIG. 8 is a diagram illustrating an example of a computing device.

Referring to FIG. 8, the vision LLM preprocessing apparatus and method can be implemented using the computing device 900.

The computing device 900 can include at least one of the processor 910, the memory 930, a user interface input device 940, a user interface output device 950, and a storage device 960 performing the communication via a bus 920. In addition, the computing device 900 can include a network interface 970 electrically connected to a network 90. The network interface 970 can transmit or receive a signal to or from another entity via the network 90.

The processor 910 can be implemented in various types such as a micro controller unit (MCU), an application processor (AP), a central processing unit (CPU), a graphics-processing unit (GPU), and a neural processing unit (NPU), and can be any semiconductor device that executes an instruction stored in the memory 930 or the storage device 960. The processor 910 can implement the functions and methods described above with respect to FIGS. 1-7.

The memory 930 and the storage device 960 can include various types of volatile or non-volatile storage media. For example, the memory can include a read-only memory (ROM) 931 and a random access memory (RAM) 932. In some implementations, the memory 930 can be disposed inside or outside the processor 910, and the memory 930 can be connected to the processor 910 via various known means.

In some implementations, at least some components or functions of the vision LLM preprocessing apparatus and method can be implemented as a program or software that is executable on the computing device 900, and the program or software can be stored in a computer-readable medium.

In some implementations, at least some components or functions of the vision LLM preprocessing apparatus and method can be implemented using the hardware or circuitry of the computing device 900, or can be implemented as separate hardware or circuitry that can be electrically connected to the computing device 900.

What is claimed is:

1. A vision large language model (LLM) preprocessing method performed by a computing device including a processor and a memory, the method comprising:
receiving, by the processor, a first image and a first prompt;
setting, by the processor, a region of interest in the first image based on the first prompt and determining, by the processor, a similarity level between an image cropped from the region of interest and the first prompt;
selectively outputting, by the processor, a second image from the region of interest based on the similarity level; and
inputting, by the processor, the output second image and the first prompt into the vision LLM.

2. The method of claim 1, wherein setting the region of interest in the first image and determining the similarity level includes:
detecting, by the processor, a candidate image from the region of interest by using an artificial intelligence-based object detection model,
calculating, by the processor, a similarity level between the detected candidate image and the first prompt, and
determining, by the processor, whether the calculated similarity level satisfies a specific criterion.

3. The method of claim 2, wherein detecting the candidate image from the region of interest includes:
outputting, by the processor, a bounding box that includes an object,
determining, by the processor, whether the output bounding box satisfies a specific condition and determining, by the processor, the object included in the bounding box as the candidate image based on the output bounding box satisfying the specific condition.

4. The method of claim 3, wherein determining whether the output bounding box satisfies the specific condition and determining the object included in the bounding box as the candidate image based on the output bounding box satisfying the specific condition includes:
determining, by the processor, the object included in the bounding box as the candidate image based on a size of the bounding box being greater than a size of the first image multiplied by a predetermined multiple.

5. The method of claim 2, wherein calculating the similarity level between the candidate image and the first prompt includes:
calculating, by the processor, the similarity level between the candidate image and the first prompt by using a sigmoid loss contrastive language-image pre-training (SIGLIP) model.

6. The method of claim 2, wherein determining whether the similarity level satisfies the specific criterion includes:
determining, by the processor, that the similarity level satisfies the specific criterion based on a highest similarity level among the calculated similarity levels exceeds a predetermined threshold criterion and outputting the second image.

7. The method of claim 1, wherein inputting of the second image and the first prompt into the vision LLM includes:
inputting, by the processor, the first image and the second image into the vision LLM.

8. The method of claim 7, wherein inputting the second image and the first prompt into the vision LLM further includes:
inputting, by the processor, the first image, the second prompt, and the first prompt into the vision LLM, the second prompt including a description of the second image.

9. The method of claim 1, wherein selectively outputting the second image to the region of interest further includes:
inputting, by the processor, the first image and the first prompt into the vision LLM in response to the second image not being output.

10. A vision large language model (LLM) preprocessing method performed by a computing device including a processor and a memory, the method comprising:
receiving, by the processor, an entire image and an input prompt;
setting, by the processor, a region of interest in the entire image based on a first prompt and determining a similarity level between a candidate image included in the region of interest and the input prompt;
determining, by the processor, the candidate image as an image of interest and outputting, based on the similarity level exceeding a threshold criterion, the determined candidate image;
inputting, by the processor, the entire image and the input prompt into the vision LLM based on the image of interest not being output; and
modifying, by the processor, the input prompt to correspond to both the entire image and the image of interest and inputting, based on the image of interest being output, the modified input prompt, the entire image, and the image of interest into the vision LLM.

11. A vision large language model (LLM) preprocessing apparatus for improving inference performance, the LLM preprocessing apparatus comprising:
at least one memory device storing program codes; and
at least one processor configured to execute the program codes to perform operations comprising:
receiving a first image and a first prompt,
setting a region of interest in the first image based on the first prompt and determining a similarity level between an image cropped from the region of interest and the first prompt,
selectively outputting a second image from the region of interest based on the similarity level, and
inputting the output second image and the first prompt into the vision LLM.

12. The apparatus of claim 11, wherein setting the region of interest in the first image and determining the similarity level includes:
detecting a candidate image from the region of interest by using an artificial intelligence-based object detection model,
calculating a similarity level between the detected candidate image and the first prompt, and
determining whether the calculated similarity level satisfies a specific criterion.

13. The apparatus of claim 12, wherein detecting the candidate image from the region of interest includes:
outputting a bounding box that includes an object,
determining whether the output bounding box satisfies a specific condition and determining the object included in the bounding box as the candidate image based on the output bounding box satisfying the specific condition.

14. The apparatus of claim 13, wherein determining whether the output bounding box satisfies the specific condition and determining the object included in the bounding box as the candidate image based on the output bounding box satisfying the specific condition includes:
determining the object included in the bounding box as the candidate image based on a size of the bounding box being greater than a size of the first image multiplied by a predetermined multiple.

15. The apparatus of claim 12, wherein calculating the similarity level between the candidate image and the first prompt includes:
calculating the similarity level between the candidate image and the first prompt by using a sigmoid loss contrastive language-image pre-training (SIGLIP) model.

16. The apparatus of claim 12, wherein determining whether the similarity level satisfies the specific criterion includes:
determining that the similarity level satisfies the specific criterion based on a highest similarity level among the calculated similarity levels exceeds a predetermined threshold criterion and outputting the second image.

17. The apparatus of claim 11, wherein inputting the second image and the first prompt into the vision LLM includes:
inputting the first image and the second image into the vision LLM.

18. The apparatus of claim 17, wherein inputting the second image and the first prompt into the vision LLM further includes:
inputting the first image, the second prompt, and the first prompt into the vision LLM, the second prompt including a description of the second image.

19. The apparatus of claim 12, wherein selectively outputting the second image from the region of interest further includes:
outputting, based on the similarity level satisfying the specific criterion, the second image, and not outputting, based on the similarity level not satisfying the specific criterion, the second image.

20. The apparatus of claim 11, wherein not selectively outputting the second image from the region of interest based on the similarity further includes:
inputting the first image and the first prompt into the vision LLM.
